(19) United States
(12) Patent Application Publication
(10) Pub. No.: US 2016/0267250 A1
(43) Pub. Date: Sep. 15, 2016

(54) Method and System for Managing and Tracking Medical and Legalized Marijuana

(71) Applicants: Thomas H. Reinheimer, Ponte Vedra Beach, FL (US); Nathan Groff, Jacksonville, FL (US)

(72) Inventors: Thomas H. Reinheimer, Ponte Vedra Beach, FL (US); Nathan Groff, Jacksonville, FL (US)

(21) Appl. No.: 15/068,955

(22) Filed: Mar. 14, 2016

Related U.S. Application Data
(60) Provisional application No. 62/133,330, filed on Mar. 14, 2015.

(51) Int. Cl. G06F 19/00; G06Q 30/06

(52) U.S. Cl. CPC G06F 19/3456; G06Q 30/0607; G06F 19/322

(57) ABSTRACT

A process for the management and tracking of medical marijuana and legalized marijuana comprising the steps of providing a system managing, tracking and identifying consumers, growers, distributors, healthcare providers and caregivers, the distribution from growers to distributors, transactions, illegal transactions, licensing, growth information, the system in communication with remote point-of-sale systems.

### BACKGROUND

With the legalization of marijuana and medical marijuana across the United States, many states are looking at methods of managing and tracking the distribution and sale of marijuana products. Although many states have legalized the distribution and sale of marijuana, there exists no inherent way to control the distribution and sale of marijuana. Furthermore, these states are taking part in a federally illegal act and may be punished for doing so. Therefore, the ability to track and enforce state laws and guidelines is imperative.

### SUMMARY

An exemplary method for managing and tracking medical marijuana and legalized marijuana includes: managing and tracking the distribution from growers to distributors, managing and tracking all transactions; identifying illegal transactions from a plurality of rules; management of the consumers of the marijuana products; management of the marijuana growers; management of the marijuana distributors; management of the healthcare providers; management of caregivers; management of licensures necessary for consumers, caregivers, healthcare providers, growers, and distributors; management and tracking of all ID cards for consumers, caregivers, growers, distributers and employees of growers and distributers; tracking and management of the products that are distributed; importation of 3^{rd} party seed information; importation of 3^{rd} party growth information; a method for law enforcement to determine eligibility of consumers, caregivers, grower and distributor employees; a method for utilizing current point of sale (POS) systems for capture of purchases; and a method of realizing all the above in real-time or near real-time.

An exemplary system for managing and tracking medical marijuana and legalized marijuana utilizing microprocessors with memory, transmission servers, telecommunication infrastructures and user interfaces includes: a central database module that keeps track of the all consumer transactions; the same database module that tracks and manages the distribution of marijuana from the growers to the distributors; the same database module that keeps track of and manages the plurality of rules established by the state; the same database module that manages the consumers, caregivers, healthcare providers, growers, and distributors; the same database module that manages the licensures of the consumers, caregivers, healthcare providers, growers, and distributors; the same database module that tracks and manages the products that are distributed; the same database module that tracks all purchases made by consumers through the distributors and/or growers; a module that calculates the appropriate taxes and fees; a module that tracks the fees collected for each transaction; a reporting module that compiles and presents data to the user in a meaningful manner; a module that alerts users of POS systems the validity of consumer and caregiver ID cards; and a module for importing 3^{rd} party data pertinent to the overall system.

In alternative format, the invention is a process for managing and tracking medical marijuana and legalized marijuana comprising the steps of providing a system comprising microprocessors with memory, transmission servers, telecommunication infrastructures and user interfaces that are interconnected in a manner allowing two-way transmission of data and information between central and remote locations; registering through said system consumers, caregivers, growers, distributors and healthcare providers in the field of medical and legalized marijuana by receiving information remotely transmitted by said consumers, caregivers, growers, distributors and healthcare providers; generating through said system ID cards for said consumer and caregivers, and for employees of said growers and distributors, and distributing said ID cards to said consumer, caregivers and said employees of said growers and distributors; generating through said system rules specific to an entity enforcing regulations related to said field of medical and legalized marijuana; importing through said system licensing, grower and distribution data into a database; capturing through said system real-time data from point-of-sale systems regarding the sale of marijuana to said consumers or caregivers; and determining through said system the legality of said sale of marijuana to said consumers or caregivers by applying said rules and transmitting through said system instructions to said point-of-sale systems to proceed with or deny said sale of marijuana.

In addition, the invention is such process wherein said step of registering consumers, caregivers, growers, distributors and healthcare providers in the field of medical and legalized marijuana by receiving information remotely transmitted by said consumers, caregivers, growers, distributors and healthcare providers comprises creating a database of said information remotely transmitted by said consumers, caregivers, growers, distributors and healthcare providers; reviewing and verifying said information remotely transmitted by said consumers, caregivers, growers, distributors and healthcare providers; and designating an appropriate status for said consumers, caregivers, growers, distributors and healthcare providers regarding the legality of each of said consumers, caregivers, growers, distributors and healthcare providers to participate; wherein said step of generating ID cards for said consumer and caregivers, and for employees of said growers and distributors, and distributing said ID cards to said consumer, caregivers and said employees of said growers and distributors comprises creating either physical or electronic ID cards for said consumer, caregivers and said employees of said growers and distributors; and distributing said ID cards to said consumer, caregivers and said employees of said growers and distributors physically or by electronic transmission; wherein said step of generating rules specific to an entity enforcing regulations related to said field of medical and legalized marijuana comprises reviewing regulations and laws of said entity; and creating and adjusting said rules based on said regulations and laws of said entity: wherein said step of importing licensing, grower and distribution data comprises scheduling importation parameters; selecting particular files to import; importing said files based on said scheduling and selecting steps; and saving said files in said database; and/or wherein said step of capturing real-time data from point-of-sale systems regarding the sale of marijuana to said consumers or caregivers comprises receiving data entered manually or automatically into said point-of sale systems.

### BRIEF DESCRIPTION OF THE DRAWINGS

Other objects and advantages of the invention will become apparent to those skilled in the relevant art(s) upon reading the following detailed description of preferred embodiments, in conjunction with the accompanying drawings, in which like reference numerals have been used to designate like elements, and in which:

FIGS. 1-6 illustrate process flowcharts providing an exemplary process of managing and tracking medical and legalized marijuana.

FIG. 7 illustrates an exemplary high-level network diagram for implementing a system to setup the use of a depository institution for the entity.

### DETAILED DESCRIPTION

A detailed description of systems and methods for tracking and managing medical marijuana and legalized marijuana is presented below. The explanation will be by way of exemplary embodiments to which the present invention is not limited.

By creating a system that enables an entity to manage and track medical and legalized marijuana, entities are capable of regulating and verifying compliance with their own laws, and the systems and methods described herein may yield many advantages over systems and methods specializing in any one of these aspects alone. By managing and tracking the complete life cycle of the marijuana plant from growth to consumption, the systems and methods described herein are capable of managing and tracking the complete life cycle of the marijuana more accurately and in a timely fashion. In particular, the purchases of medical marijuana are authorized through the system that verifies 100% compliance with current laws within the state in real time. In this way, the system and methods can also record all transactions to ensure 100% accuracy of inventory and sales. Furthermore, the systems and methods embody the methods in which consumers, caregivers, healthcare providers, distributors, and growers currently are using to distribute and sell the medical and legalized marijuana.

### Process Overview

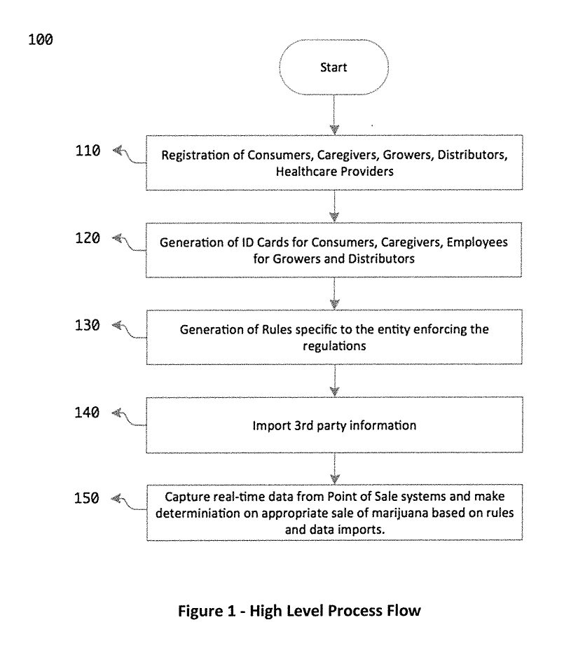

FIGS. 1-6 illustrate exemplary steps for a process 100 for managing and tracking medical marijuana and legalized marijuana. Not all steps of FIG. 1 have to occur in the order shown, as will be apparent to persons skilled in the relevant art(s) based on the teachings herein. Other operational and structural embodiments will be apparent to persons skilled in the relevant art(s) based on following discussions. These steps are described in detail below. The process requires the use of microprocessors with memory, transmission servers, telecommunication infrastructures and user interfaces that are interconnected in a manner to allow remote two-way transmission of data and information between central and remote locations.

First in step 110, the registrations of all Participants in the program are completed. The term Participants includes but is not limited to Consumers, Caregivers, Growers, Distributors, and Healthcare Providers. For example, this may be done through software providing a programmatic interface on the web, wherein pertinent registration information from Participants is transmitted between remote computer microprocessors (e.g., desktops, laptops, smart phones, etc.) and a centralized database on the system computer.

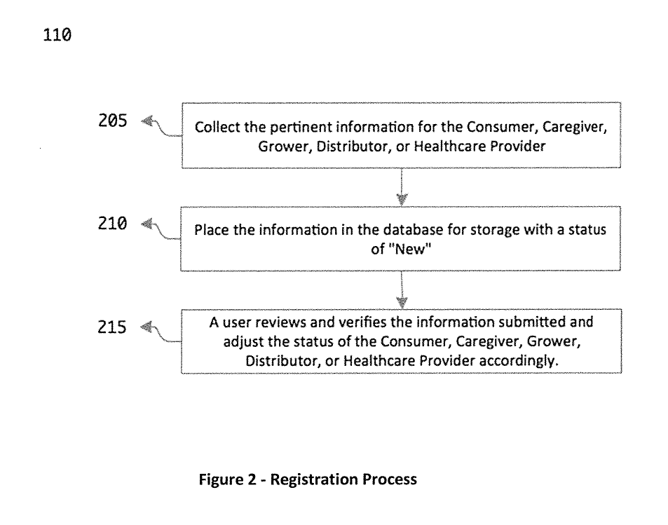

FIG. 2 illustrates detailed steps for executing step 110. In Step 205, the system must collect all pertinent information associated with the Participants. In one exemplary implementation this information will be collected through distinct user interfaces for each of the Participants. This information will include basic demographic information along with documents for proof of licensure, proof of medical condition etc.

Next in step 210, the information collected will be placed in the centralized database for safekeeping and given a status of “New”. This “New” status will trigger employees to review the information submitted by the Participants.

Next in step 215, the employee will review the information submitted by the Participants for its validity and completeness. Based on the rules of the particular State the application will be either approved, denied, or a request for more information initiated to the Participant. In one exemplary implementation the list of “New” applications will be displayed to a user through a website and the user will be able to make a determination based on the information presented.

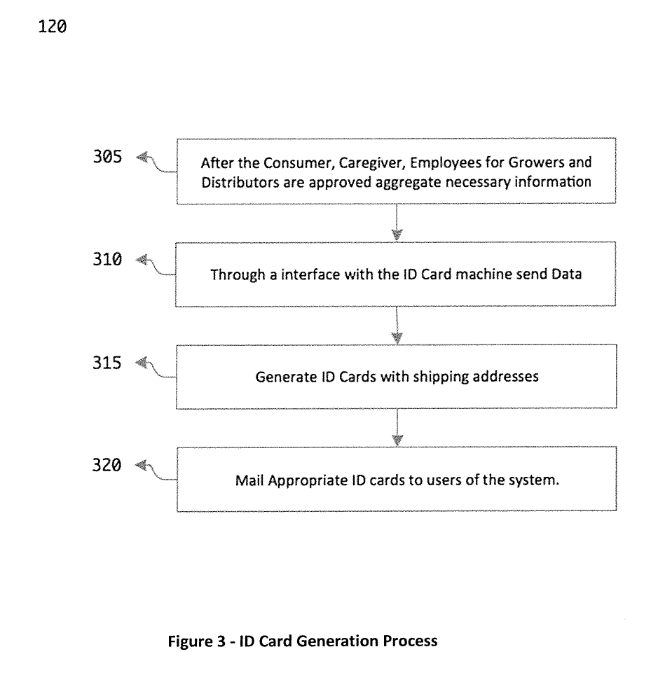

FIG. 3 illustrates detailed steps for executing step 120. In step 120, ID Cards for Consumers, Caregivers, Grower and Distributor employees, and Healthcare Providers will be generated. In one embodiment these ID Cards will be created using an ID Card printer. In another exemplary embodiment the ID Cards can be stored on a mobile device such as a smart phone. These cards will have distinct information based on the group the card is being printed/created for.

In step 305, the information gathered for Consumers, Caregivers, Growers, Distributors, and Healthcare Providers that have been approved are aggregated with the appropriated data into their specific groups. In one embodiment the system will generate a distinct data file for each group.

In step 310, in one exemplary embodiment the data file generated in step 303 can be imported into an ID Card Creation machine where ID Cards are generated for the qualified Consumers, Caregivers, Growers, Distributors, and Healthcare Providers.

In step 315, shipping labels are generated for the appropriate cards for the Consumers, Caregivers, Growers, Distributors, and Healthcare Providers. In one exemplary embodiment the ID Cards are automatically stuffed into envelopes and the shipping labels placed on the outside of the envelopes ready for shipment.

In step 320, the ID Cards are delivered to the appropriate Consumers, Caregivers, Growers, Distributors, and Healthcare Providers.

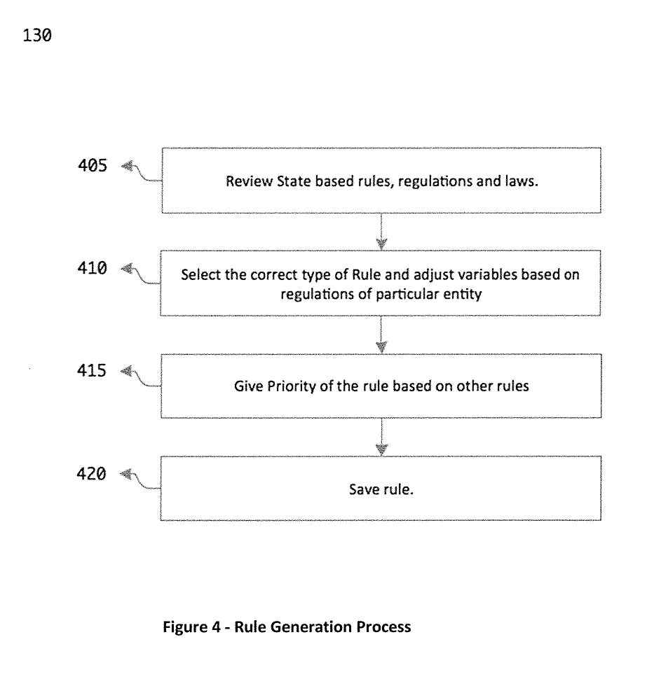

In FIG. 4, detailed steps to for executing step 130 are detailed. In step 130, Rules specific for the particular client are created. In one embodiment these rules are created through a software interface where certain parameters are entered. These rules are specific to each client and follow the laws and rules that are created in each state.

First in step 405, the state based statutes, rules, and laws are reviewed to determine the rules that will apply for the particular client. In one exemplary embodiment, a person will review these rules and compile a file (spreadsheet, CSV, text file, etc.) that can be imported into the system to generate the rules.

Next in step 410, the system is configured with the rules that have been compiled in step 405. In one exemplary embodiment, a person enters these rules into the system, configuring the specific rules for the client.

Next in step 415, the hierarchy of the rules is created. This hierarchy created a particular order in which each rule will be checked for each and every transaction that is submitted to the system. In one exemplary implementation, a user interface within the software system is used to drag and drop the different rules to place them in order of importance and execution.

Next in step 420, the rules are turned on for the state. In one exemplary implementation, using a user interface within the software system to check the rules that will be used within the system.

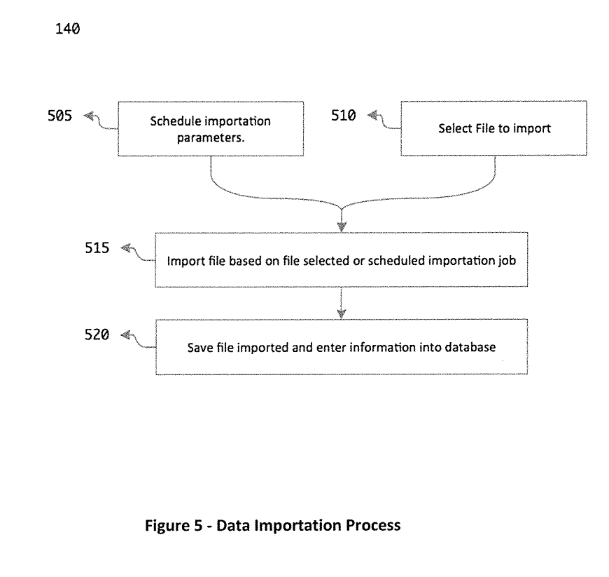

In FIG. 5, detailed steps for executing step 140 are detailed. In step 140, External Information such as Licensing, Grower, and Distribution information are imported into the system. In one exemplary embodiment the importation of these files occurs in an automated manner. These External Information data points are used to track the seed-to-sale process of medical and legalized marijuana.

First in step 505, a method to set up automated importation is described. In one exemplary embodiment a web based user interface is used to set up parameters (e.g., location, time, file type) are selected to import the particular data into the database.

In step 510, another embodiment which consists of manual importation is shown. In this embodiment a user selects a file to import and the appropriate parameters before clicking an import button on the web based user interface.

Next in step 515, the actual importation of the file is conducted. This importation places the appropriate data into the correct data tables within the centralized database. In one exemplary embodiment this importation process is the same for both the automated importation process 505 and the manual importation process 510.

Next in step 520, the file that was imported is saved to a storage location and information is entered into the database that the importation is complete. In one exemplary embodiment statuses of the importation process are stored. Whether the importation concluded with or without errors.

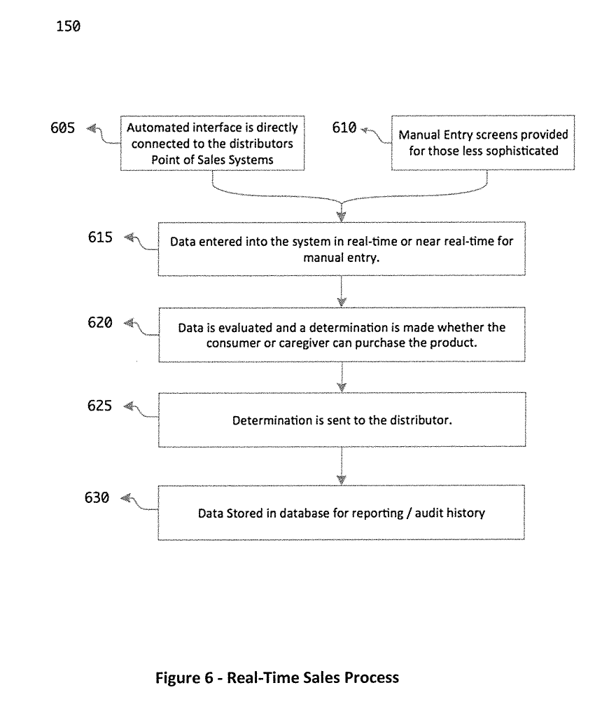

In FIG. 6, the detailed steps to execute step 150 are shown. In Step 605 a method for automated entry of sale information is shown. In one exemplary embodiment a web service would be used to transmit necessary information directly from a point of sale device to the database.

In another embodiment for data entry Step 605 is show as a method of entering the sales information manually. In one exemplary embodiment a web-based user interface is used to allow employees to enter information into the database.

Next in step 615, the data will be submitted to the database for storage in real time. This can occur as an automated interface or manual entry as discussed in steps 605 and 610 above.

Next in step 620, the system evaluates the data entered and makes a determination whether the purchaser can actually make the purchase of the medical marijuana or legalized marijuana. In one exemplary embodiment the rules that were created in step 130 are used to make the determination programmatically.

Next in step 625, the determination is sent to the seller of the medical marijuana or legalized marijuana informing them whether a sale can be made or not, with explanation. In one embodiment the determination is visible through the point of sale system the seller is using.

Next in step 630, the determination information and other pertinent data is stored in the database for reporting and audit history needs.

### System Overview

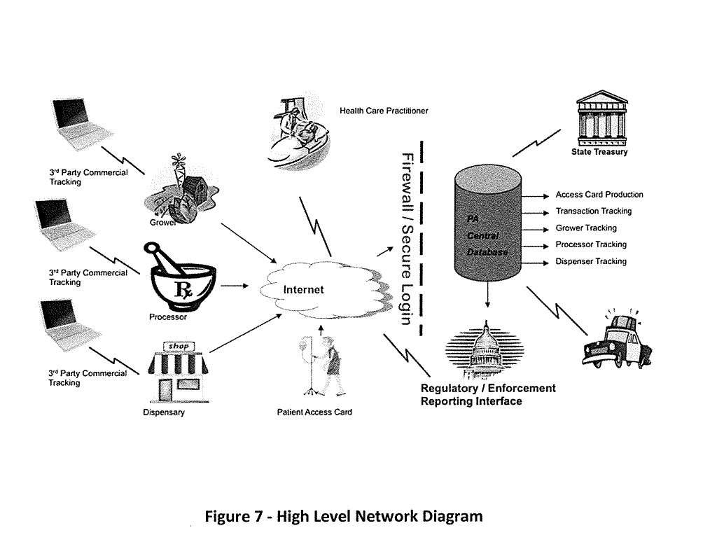

FIG. 7 illustrates an exemplary high-level solution design for implementing a system for managing and tracking medical marijuana and legalized marijuana.

As shown in FIG. 7 the system can be employed in conjunction with a computer-based system, where elements can be implemented in hardware, software, firmware, or combinations thereof. The overall system includes Internet infrastructure, regulator interface, licensee interface, telecommunication infrastructure, and database that are interconnected in a manner to allow remote two-way transmission of data and information between central and remote locations.

In one embodiment the internet infrastructure is a cloud based infrastructure that allows for the easy compilation of computer resources, that allows the system to easily scale as demands grow for the system.

In one exemplary embodiment the telecommunication infrastructure is also a cloud base infrastructure using VOIP phones and IVR systems to allow for the easy expansion of the systems. This ability to use the VOIP phones also allows our employees to be anywhere in the world where they have access to the internet.

The regulator interface in one embodiment, allows the clients of the system to monitor and track all transactions within the system. This user interface allows the clients to generate reports, see alerts, determine the validity of transactions, view trends that are occurring in their respective industry, etc.

The Licensee interface in one embodiment, allows the licensees to see all of their transactions that they have conducted on the system. This allows them to audit their transactions in a real time manner. This interface also allows the licensees to update, modify, and delete transactions as necessary.

The database in one embodiment is a transactional database and is the central part of the system and houses all of the data pertinent to the system and stores and records all transactions within the solution. The database in one embodiment can also serve as the reporting database for the licensee's and clients.

The present invention has been described with reference to several exemplary embodiments, however, it will be readily apparent to persons of skill in the relevant art(s) that it is possible to embody the invention in specific forms other than those of the exemplary embodiments described above. This may be done without departing from the spirit of the invention. These exemplary embodiments are merely illustrative and should not be considered restrictive in any way. The scope of the invention will be given by the claims to the invention, rather than the preceding description, and all variations and equivalents which fall within the range of the claims are intended to be embraced therein.

1. A medical and legalized marijuana management and tracking process comprising the steps of:
providing a system comprising microprocessors with memory, transmission servers, telecommunication infrastructures and user interfaces that are interconnected in a manner allowing two-way transmission of data and information between central and remote locations;
registering through said system consumers, caregivers, growers, distributors and healthcare providers in the field of medical and legalized marijuana by receiving information remotely transmitted by said consumers, caregivers, growers, distributors and healthcare providers;
generating through said system ID cards for said consumer and caregivers, and for employees of said growers and distributors, and distributing said ID cards to said consumer, caregivers and said employees of said growers and distributors;
generating through said system rules specific to an entity enforcing regulations related to said field of medical and legalized marijuana;
importing through said system licensing, grower and distribution data into a database;
capturing through said system real-time data from point-of-sale systems regarding the sale of marijuana to said consumers or caregivers; and
determining through said system the legality of said sale of marijuana to said consumers or caregivers by applying said rules and transmitting through said system instructions to said point-of-sale systems to proceed with or deny said sale of marijuana.

2. The process of claim 1, wherein said step of registering consumers, caregivers, growers, distributors and healthcare providers in the field of medical and legalized marijuana by receiving information remotely transmitted by said consumers, caregivers, growers, distributors and healthcare providers comprises:
creating a database of said information remotely transmitted by said consumers, caregivers, growers, distributors and healthcare providers;
reviewing and verifying said information remotely transmitted by said consumers, caregivers, growers, distributors and healthcare providers; and
designating an appropriate status for said consumers, caregivers, growers, distributors and healthcare providers regarding the legality of each of said consumers, caregivers, growers, distributors and healthcare providers to participate.

3. The process of claim 1, wherein said step of generating ID cards for said consumer and caregivers, and for employees of said growers and distributors, and distributing said ID cards to said consumer, caregivers and said employees of said growers and distributors comprises:
creating either physical or electronic ID cards for said consumer, caregivers and said employees of said growers and distributors; and
distributing said ID cards to said consumer, caregivers and said employees of said growers and distributors physically or by electronic transmission.

4. The process of claim 1, wherein said step of generating rules specific to an entity enforcing regulations related to said field of medical and legalized marijuana comprises:
reviewing regulations and laws of said entity; and
creating and adjusting said rules based on said regulations and laws of said entity.

5. The process of claim 1, wherein said step of importing licensing, grower and distribution data comprises:
scheduling importation parameters;
selecting particular files to import;
importing said files based on said scheduling and selecting steps; and
saving said files in said database.

6. The process of claim 1, wherein said step of capturing real-time data from point-of-sale systems regarding the sale of marijuana to said consumers or caregivers comprises:
receiving data entered manually or automatically into said point-of sale systems.

7. The process of claim 2, wherein said step of generating ID cards for said consumer and caregivers, and for employees of said growers and distributors, and distributing said ID cards to said consumer, caregivers and said employees of said growers and distributors comprises:
creating either physical or electronic ID cards for said consumer, caregivers and said employees of said growers and distributors; and
distributing said ID cards to said consumer, caregivers and said employees of said growers and distributors physically or by electronic transmission.

8. The process of claim 2, wherein said step of generating rules specific to an entity enforcing regulations related to said field of medical and legalized marijuana comprises:
reviewing regulations and laws of said entity; and
creating and adjusting said rules based on said regulations and laws of said entity.

9. The process of claim 2, wherein said step of importing licensing, grower and distribution data comprises:
scheduling importation parameters;
selecting particular files to import;
importing said files based on said scheduling and selecting steps; and
saving said files in said database.

10. The process of claim 2, wherein said step of capturing real-time data from point-of-sale systems regarding the sale of marijuana to said consumers or caregivers comprises:
receiving data entered manually or automatically into said point-of sale systems.

11. The process of claim 3, wherein said step of generating rules specific to an entity enforcing regulations related to said field of medical and legalized marijuana comprises:
reviewing regulations and laws of said entity; and
creating and adjusting said rules based on said regulations and laws of said entity.

12. The process of claim 3, wherein said step of importing licensing, grower and distribution data comprises:
scheduling importation parameters;
selecting particular files to import;
importing said files based on said scheduling and selecting steps; and
saving said files in said database.

13. The process of claim 3, wherein said step of capturing real-time data from point-of-sale systems regarding the sale of marijuana to said consumers or caregivers comprises:
receiving data entered manually or automatically into said point-of sale systems.

14. The process of claim 4, wherein said step of importing licensing, grower and distribution data comprises:
scheduling importation parameters;
selecting particular files to import;
importing said files based on said scheduling and selecting steps; and
saving said files in said database.

15. The process of claim 4, wherein said step of capturing real-time data from point-of-sale systems regarding the sale of marijuana to said consumers or caregivers comprises:
receiving data entered manually or automatically into said point-of sale systems.

16. The process of claim 5, wherein said step of capturing real-time data from point-of-sale systems regarding the sale of marijuana to said consumers or caregivers comprises:
receiving data entered manually or automatically into said point-of sale systems.

17. The process of claim 7, wherein said step of generating rules specific to an entity enforcing regulations related to said field of medical and legalized marijuana comprises:
reviewing regulations and laws of said entity; and
creating and adjusting said rules based on said regulations and laws of said entity.

18. The process of claim 7, wherein said step of importing licensing, grower and distribution data comprises:
scheduling importation parameters;
selecting particular files to import;
importing said files based on said scheduling and selecting steps; and
saving said files in said database.

19. The process of claim 7, wherein said step of capturing real-time data from point-of-sale systems regarding the sale of marijuana to said consumers or caregivers comprises:
receiving data entered manually or automatically into said point-of sale systems.

20. The process of claim 8, wherein said step of importing licensing, grower and distribution data comprises:
scheduling importation parameters;
selecting particular files to import;
importing said files based on said scheduling and selecting steps; and
saving said files in said database.

21. The process of claim 8, wherein said step of capturing real-time data from point-of-sale systems regarding the sale of marijuana to said consumers or caregivers comprises:
receiving data entered manually or automatically into said point-of sale systems.

22. The process of claim 9, wherein said step of capturing real-time data from point-of-sale systems regarding the sale of marijuana to said consumers or caregivers comprises:
receiving data entered manually or automatically into said point-of sale systems.

23. The process of claim 17, wherein said step of importing licensing, grower and distribution data comprises:
scheduling importation parameters;
selecting particular files to import;
importing said files based on said scheduling and selecting steps; and
saving said files in said database.

24. The process of claim 17, wherein said step of capturing real-time data from point-of-sale systems regarding the sale of marijuana to said consumers or caregivers comprises:
receiving data entered manually or automatically into said point-of sale systems.

25. The process of claim 20, wherein said step of capturing real-time data from point-of-sale systems regarding the sale of marijuana to said consumers or caregivers comprises:
receiving data entered manually or automatically into said point-of sale systems.

26. The process of claim 23, wherein said step of capturing real-time data from point-of-sale systems regarding the sale of marijuana to said consumers or caregivers comprises:
receiving data entered manually or automatically into said point-of sale systems.

27. The process of claim 12, wherein said step of capturing real-time data from point-of-sale systems regarding the sale of marijuana to said consumers or caregivers comprises:
receiving data entered manually or automatically into said point-of sale systems.

28. The process of claim 14, wherein said step of capturing real-time data from point-of-sale systems regarding the sale of marijuana to said consumers or caregivers comprises:
receiving data entered manually or automatically into said point-of sale systems.

29. The process of claim 11, wherein said step of capturing real-time data from point-of-sale systems regarding the sale of marijuana to said consumers or caregivers comprises:
receiving data entered manually or automatically into said point-of sale systems.

30. The process of claim 11, wherein said step of importing licensing, grower and distribution data comprises:
scheduling importation parameters;
selecting particular files to import;
importing said files based on said scheduling and selecting steps; and
saving said files in said database.

31. A medical and legalized marijuana management and tracking process comprising the steps of:
providing a system comprising microprocessors with memory, transmission servers, telecommunication infrastructures and user interfaces that are interconnected in a manner allowing two-way transmission of data and information between central and remote locations;
managing and tracking through said system the distribution from growers to distributors;
managing and tracking through said system all transactions;
identifying through said system illegal transactions from a plurality of rules;
managing through said system the consumers of the marijuana products, the marijuana growers; the marijuana distributors, the healthcare providers, and the caregivers;
managing through said system the licensures necessary for said consumers, caregivers, healthcare providers, growers, and distributors;
managing and tracking through said system of ID cards for said consumers, caregivers, growers, distributers and employees of growers and distributers;
tracking and managing through said system the products that are distributed;
importing through said system 3^{rd} party seed information and growth information;
determining through said system eligibility of said consumers, caregivers, grower and distributor employees; and
utilizing through said system current point of sale (POS) systems for capture of purchases.
